(19) United States
(12) Patent Application Publication
(10) Pub. No.: US 2017/0207585 A1
(43) Pub. Date: Jul. 20, 2017

(54) TRACEABLE CABLE SYSTEM, TRACEABLE CABLE ASSEMBLY AND CONNECTOR

(71) Applicant: CORNING OPTICAL COMMUNICATIONS LLC, Hickory, NC (US)

(72) Inventors: Douglas Llewellyn Butler, Painted Post, NY (US); Micah Colen Isenhour, Lincolnton, NC (US); Jerald Lee Overcash, China Grove, NC (US)

(21) Appl. No.: 15/000,128

(22) Filed: Jan. 19, 2016

(51) Int. Cl. H01R 13/717; H02G 15/02; H01R 13/629; H01B 11/22

(52) U.S. Cl. CPC H01R 13/7172; H01B 11/22; H02G 15/02; H01R 13/629

(57) ABSTRACT

A traceable cable assembly includes a traceable cable having at least one data transmission element, a jacket at least partially surrounding the at least one data transmission element, and a tracing optical fiber incorporated with and extending along at least a portion of a length of the traceable cable. The traceable cable assembly also includes a connector provided at each end of the traceable cable. Each connector has a connector housing having opposed first and second ends, the second end being coupled to the traceable cable, and a diffuser supported by the connector housing. The connector housing is configured to receive tracer light from the tracing optical fiber and allow the tracer light to leave the connector housing. The diffuser is also configured to diffuse the tracer light leaving the connector housing.

### BACKGROUND

This disclosure generally relates to traceable cable assemblies and systems. More particularly, the present disclosure relates to traceable cable assemblies and systems provided with connectors to facilitate traceability.

Computer networks continue to increase in size and complexity. Businesses and individuals rely on these networks to store, transmit, and receive critical data at high speeds. Even with the expansion of wireless technology, wired connections remain critical to the operation of computer networks, including enterprise data centers. Portions of these wired computer networks are regularly subject to removal, replacement, upgrade, or other moves and changes. To ensure the continued proper operation of each network, the maze of cables connecting the individual components must be precisely understood and properly connected between specific ports.

In many cases, a data center's cables, often called patch cords, are required to bridge several meters across the data center. The cables may begin in one equipment rack, run through the floor or other conduit, and terminate at a component in a second equipment rack.

As a result, there is a need for an improved cable or cable assembly that allows a select cable to be quickly and easily traceable for the purpose of identifying an approximate terminal end of a given cable that is being replaced, relocated, or tested. Particularly, there is a need for a connector that allows for tracer light to be effectively coupled into and out of the cable to facilitate tracing.

### SUMMARY

The present disclosure describes connectors, such as fiber optic connectors, provided with diffusers that are configured to emit, and optionally facilitate receipt of, tracer light. When emitting tracer light from the connector, the emitted tracer light may be used by a technician to identify the appropriate connector of a traceable cable assembly or system. Additionally, the diffuser may provide, or identify, a location on the connector where tracer light may be received by the connector, so that the light received by the connector can be transmitted along a fiber optic cable, such as to a remote connector, during a tracing operation.

One embodiment of the present disclosure relates to a traceable cable assembly that includes a traceable cable having at least one data transmission element, a jacket at least partially surrounding the at least one data transmission element, and a tracing optical fiber incorporated with and extending along at least a portion of a length of the traceable cable. The traceable cable assembly also includes a connector provided at each end of the traceable cable. Each connector has a connector housing having opposed first and second ends, the second end being coupled to the traceable cable, and a diffuser supported by the connector housing. The connector housing is configured to receive tracer light from the tracing optical fiber and allow the tracer light to leave the connector housing. The diffuser is also configured to diffuse the tracer light leaving the connector housing.

Another embodiment of the present disclosure includes a traceable cable system comprising a traceable cable, a connector provided at each end of the traceable cable, and a launch tool. The traceable cable may include at least one data transmission element, a jacket at least partially surrounding the at least one data transmission element, and a tracing optical fiber incorporated with and extending along at least a portion of a length of the traceable cable. Each connector may comprise a connector housing having opposed first and second ends, the second end being coupled to the traceable cable, and a diffuser supported by the connector housing. The launch tool may comprise a light source configured to produce tracer light, and a waveguide having opposite receiving and emissions ends, wherein the receiving end is in optical communication with the light source. The launch tool is configured to at least indirectly provide tracer light to the tracing optical fiber proximate one end of the traceable cable. The connector housing coupled to an opposite end of the traceable cable is configured to receive the tracer light from the tracing optical fiber and allow the tracer light to leave the connector housing. The diffuser is configured to diffuse the tracer light leaving the connector housing such that the tracer light is visible proximate the opposite end of the traceable cable.

Yet another embodiment relates to another traceable cable assembly, comprising a traceable cable and a connector provided at each end of the traceable cable. The traceable cable may comprise at least one data transmission element, a jacket at least partially surrounding the at least one data transmission element, and a tracing optical fiber incorporated with and extending along at least a portion of a length of the traceable cable. Each connector may comprise a connector housing having opposed first and second ends, the second end being coupled to the traceable cable, and a diffuser supported by the connector housing. The connector housing includes a path that directs the tracer optical fiber from the traceable cable to the diffuser. The tracing optical fiber is looped one or more times in the path of the connector housing. The diffuser is configured to receive tracer light from the tracing optical fiber and diffuse the tracer light such that the tracer light is visible proximate the connector that includes the diffuser.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments. Features and attributes associated with any of the embodiments shown or described may be applied to other embodiments shown, described, or appreciated based on this disclosure.

FIG. 1 is a schematic view of a traceable cable system.

FIG. 2 is a transverse cross sectional view of a traceable cable of the traceable cable system of FIG. 1, in accordance with an embodiment of the present disclosure.

FIG. 3 is a diagrammatic illustration of a launch tool of the traceable cable system of FIG. 1, in accordance with an embodiment of the present disclosure.

FIG. 4 is a perspective view of a connector disconnected from a waveguide attachment of a launch tool according to an embodiment.

FIG. 5 is a detailed perspective end view of a portion of the waveguide attachment of FIG. 4.

FIG. 6 is a schematic, partially cut away view of selected elements of FIG. 4 when connected.

FIG. 7 is a detailed perspective end view of a portion of a delivery waveguide according to another embodiment.

FIG. 8 is a schematic, partially cut away view of the delivery waveguide of FIG. 7 connected to the connector of FIG. 4.

FIG. 9 is a perspective view of a connector according to another embodiment, with an upper housing removed.

### DESCRIPTION

Various embodiments will be further clarified by examples in the description below. In general, the description relates to traceable cable systems and components thereof. More particularly, this disclosure provides various embodiments of connectors and launch tools for providing light into, and/or emitting light received from, an optical fiber, for example a tracing optical fiber, associated with a traceable cable.

The connectors are generally provided with diffusers configured to act as at least an emission location for tracer light exiting the connector. In some embodiments, the diffusers also act as interfaces through which tracer light may be received by the connector and conveyed to a tracing optical fiber. In other embodiments, the connectors receive tracer light from a launch tool by means other than through the diffuser of the connector. In some instances, the diffuser may be configured to be shifted outside of an optical path of the tracer light, the optical path, for example, extending from the launch tool to the tracing optical fiber.

To provide tracer light into the connectors of the present disclosure, launch tools having corresponding waveguide attachments may be used. In some embodiments, the waveguide attachments may be configured to maximize transmission and minimize loss of tracer light passing from the launch tool into the diffuser. In another embodiment, the waveguide attachment may be configured to act upon the diffuser of the connector to move the diffuser out of the optical path to the optical fiber. Each of these embodiments is described in further detail below in association with the corresponding figures.

### An Example Traceable Cable System

A problem that occurs in data centers or similar network locations is congestion and clutter caused by large quantities of cables. Network operators frequently desire to change connections to accommodate moves, adds, and changes in the network. However, such congestion makes it difficult to trace a particular cable from the source to the receiver, which may be required to perform the moves, adds, and changes in the network.

The various embodiments described herein may be incorporated into a tracing system that makes the process of performing a trace or otherwise identifying a cable in a congested environment relatively convenient and fast for a technician. As a result, the technician can reliably identify the one cable in question (which may be a telecommunication patch cord) from amongst many other cables (which may also be telecommunication patch cords). In some cases, the technician may be able to reliably identify the cable in question along its length once tracing capability at one end of the cable has been activated. The tracing system may also have the advantage of being an optically-activated tracing system using only passive tracing elements associated with the cable (although active tracing elements may still be provided in addition to the passive tracing elements, if desired). A method of tracing a cable may include using an optical signal or stimulus, for example, a visible spot of light, that is provided by a source external to the cable. The source external to the cable may alternatively provide non-visible light for tracing purposes.

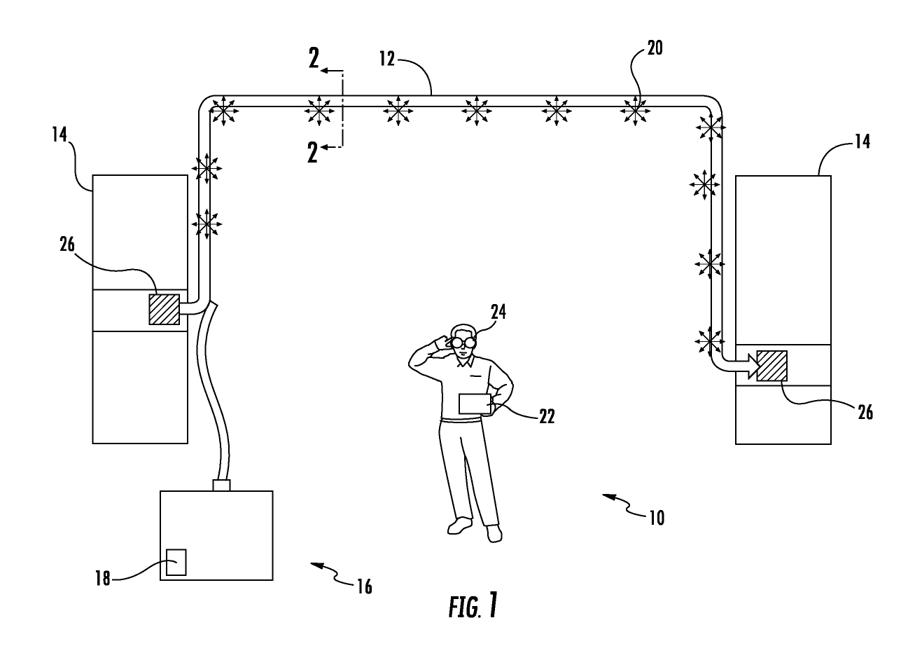

An example tracing system 10 is schematically illustrated in FIG. 1. The tracing system 10 includes a traceable cable 12 (“cable 12”) extending between two locations, such as two equipment racks 14 in a data center, telecommunications room, or the like. The cable 12 may, for example, operably connect a port on a server in one of the equipment racks 14 with a port on a server in another of the equipment racks 14.

The tracing system 10 may also include a launch tool 16 configured to connect to, or otherwise be associated with, the cable 12 and provide tracer light from a light source 18. The tracer light may provide illumination at discrete points along the cable 12. Such discrete points are schematically represented by element 20 in FIG. 1 and will be referred to herein as emission points 20 or tracer locations 20. In alternative embodiments, the cable 12 may be configured to provide more continuous emission along its length, or illumination only at or near ends of the cable 12.

The tracing system 10 may optionally further include a controller 22 and an observation tool 24. The controller 22, in the embodiment shown, is a remote control unit configured to communicate with the launch tool 16. A technician may, for example, use the controller 22 to send operational commands to the launch tool 16 to control operation of the light source 18. The observation tool 24 may comprise a pair of glasses configured to enhance visibility of the tracer light emitted by the cable 12. Enhanced visibility may be achieved by enhancing visibility of the wavelength of the tracer light and/or by dampening other visible wavelengths. In embodiments where the tracer light has a non-visible wavelength, the observation tool 24 may include sensors configured to detect such light and electronics configured to display a representation of such light to a technician.

The cable 12, in one embodiment, is part of a cable assembly that includes connectors 26, wherein the connectors are schematically illustrated in FIG. 1, respectively provided on the ends of the cable 12. The connectors 26 may be respectively mounted on the opposite ends of the cable 12 to allow the cable assembly to function as a telecommunications patch cord between different components of a network. The connectors 26 may vary widely depending on the nature of the cable 12 (e.g., the quantity and type of signals transmitted) and the components being connected. The distance between the connectors 26 on opposite ends of the cable 12 may define a length of the cable. The length of the cable 12 may be at least about 1 meter or even several tens of meters, such as thirty meters or more, depending on the intended use of the cable 12.

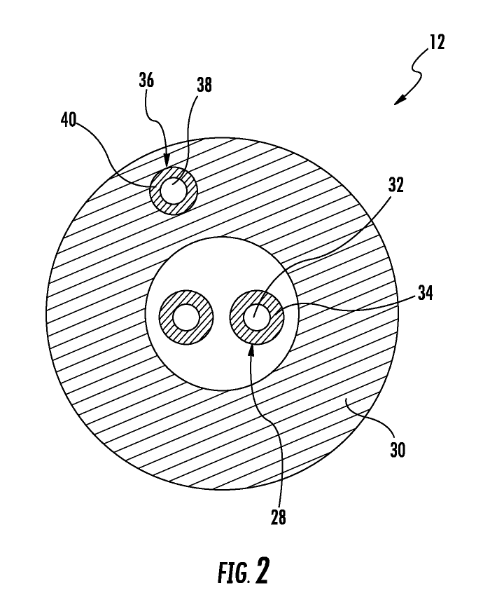

FIG. 2 is a cross section of the cable 12 in accordance with one possible embodiment. As shown in FIG. 2, the cable 12 includes a jacket 30 surrounding at least one data transmission element 28. Although two data transmission elements 28 are shown in this embodiment, there may be a single data transmission element or a larger number of data transmission elements within the jacket 30. In general, each data transmission element 28 is a structure capable of carrying a data signal from one end of the cable 12 to the other end of the cable. For example, the data transmission element 28 may be configured to transmit an electrical signal using a copper wire or other electrically conductive material. Alternatively, the data transmission element 28 may be configured to transmit an optical signal by conducting electromagnetic waves to carry data from one location to another. The data transmission element 28 shown in FIG. 2 is of the latter type (i.e., an optical transmission element) having a core 32 and a cladding 34. There may be strength members (e.g., aramid yarns) or other elements located within the cable 12 between the data transmission elements 28 and the jacket 30.

Still referring to FIG. 2, the cable 12 also includes at least one tracer element, which is shown in the form of a tracing optical fiber 36 configured to transmit and emit tracer light for visualization purposes. The tracing optical fiber 36 may be incorporated as part of the cable 12 in several configurations. In the embodiment shown in FIG. 2, the tracing optical fiber 36 is embedded within a portion of the jacket 30. In other embodiments, the tracing optical fiber 36 may be adjacent to the data transmission element 28, e.g. inside a conduit defined by the jacket 30. In yet other embodiments, the tracing optical fiber 36 may be provided on, mounted to, or otherwise attached to an outside of the jacket 30.

The tracing optical fiber 36 includes a core 38 having a first index of refraction, and a cladding 40 at least partially surrounding the core 38. The cladding 40 has a second index of refraction different than the first index of refraction. The tracing optical fiber 36 may be configured to emit light at ends of the tracing optical fiber and/or along the length of the tracing optical fiber in a continuous or periodic manner. The tracing optical fiber 36 may, for example, include features or otherwise be configured to scatter light at discrete locations along the length of the tracing optical fiber. Such periodic scattering of light may form the emission points 20 (FIG. 1) of the cable 12, alone or in combination with features on the jacket 30, such as openings/windows (not shown) in the jacket or portions of reduced material thickness between the tracing optical fiber 36 and an outer surface of the jacket. The term “side-emitting optical fiber” may be used to refer to the tracing optical fiber 36 in embodiments where light is scattered along the length of the tracing optical fiber in a periodic or continuous manner.

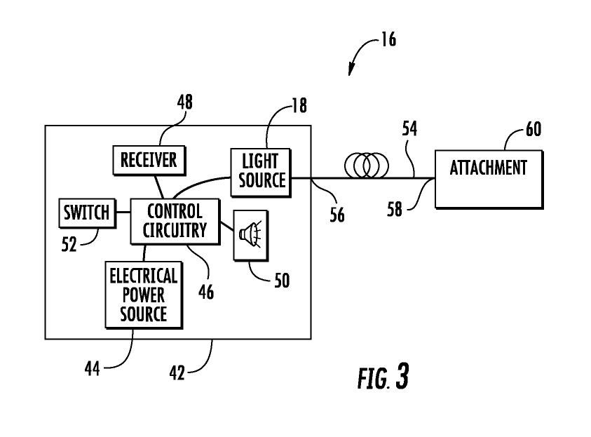

Turning to FIG. 3, an example of the launch tool 16 is diagrammatically shown. The launch tool 16 may have a number of elements stored in a housing 42, including the light source 18 (e.g., a red or green laser), an electrical power source 44 (e.g., batteries), and control circuitry 46 respectively connected to other components of the launch tool, such as to control the light source 18 and power usage. A receiver 48 or other wireless communication components may be also be included in or on the housing 42 to receive commands from the controller 22 (FIG. 1). Furthermore, the launch tool 16 may include an on-off switch 52, and it may also include one or more user interface features, such as a speaker 50 to allow for the generation of audible signals. The housing 42 may be approximately the size of a standard flashlight or smaller. The housing 42 should be sufficiently durable to protect the launch tool 16, even in the event of a drop onto a hard surface.

In one embodiment, the light source 18 may be a semiconductor laser configured for emitting green light at a wavelength between 510-540 nm. Alternatively, other colors/wavelengths may be emitted, such as red light from approximately 620-650 nm. In other embodiments, non-laser light sources may be used, such as light emitting diodes (LEDs). Several factors may be considered when selecting an appropriate light source 18, and the factors may include, but are not limited to, visibility, cost, eye safety, peak power, power consumption, size, and commercial availability.

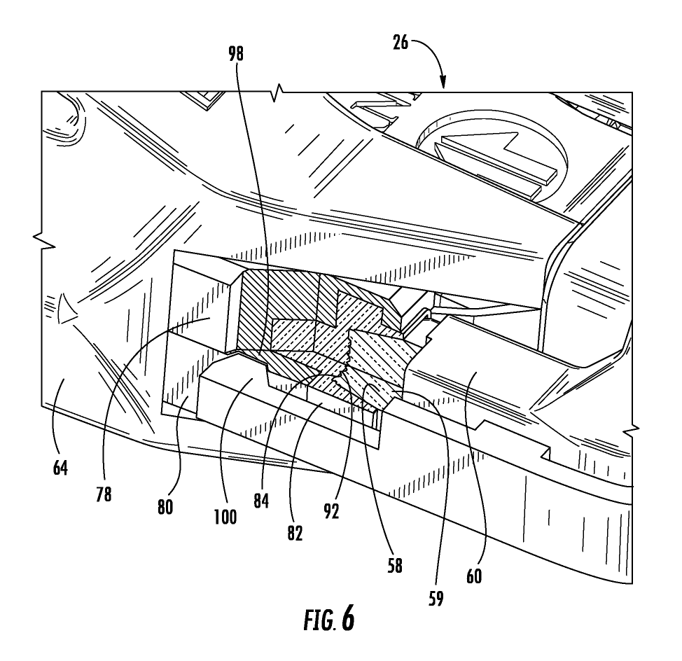

The launch tool 16 may include a delivery waveguide 54, which is sometimes referred to as an umbilical. The delivery waveguide 54 provides a path for transmitting light from a receiving end 56 of the delivery waveguide, which is in communication with the light source 18, to an emission end 58 of the delivery waveguide, configured to emit the light for eventual receipt by the tracer optical fiber 36 (FIG. 2). The launch tool 16 or housing 42 may optionally include one or more optical components configured to help couple light from the light source 18 into the receiving end 56 of the delivery waveguide 54. The delivery waveguide 54 may be several meters in length, for example, so that the housing 42 of the launch tool 16 can be placed on the ground while the emission end 58 of the delivery waveguide 54 is at least indirectly coupled with the cable 12 several meters away. The delivery waveguide 54 may be constructed of various optical components or segments in communication with one another. For example, a majority of the delivery waveguide 54 may take the form of an optical fiber, providing substantial length and flexibility to the delivery waveguide 54. A terminal portion, i.e. adjacent to the emission end 58, of the delivery waveguide 54 may constitute a light pipe 59 (FIG. 6) having a solid or hollow body of substantially transparent material in optical communication with an optical fiber that optionally provides the majority of the length of the delivery waveguide. The use of a light pipe 59 may be used to increase the emission area of the emission end 58 of the delivery waveguide 54.

An attachment 60, also referred to as a waveguide attachment (shown schematically in FIG. 3), may be mounted to, or otherwise provided at or near, the emission end 58 of the delivery waveguide 54 to secure the delivery waveguide to the cable 12, or connector 26, and keep the emission end of the delivery waveguide in a desired position.

### Exemplary Embodiments

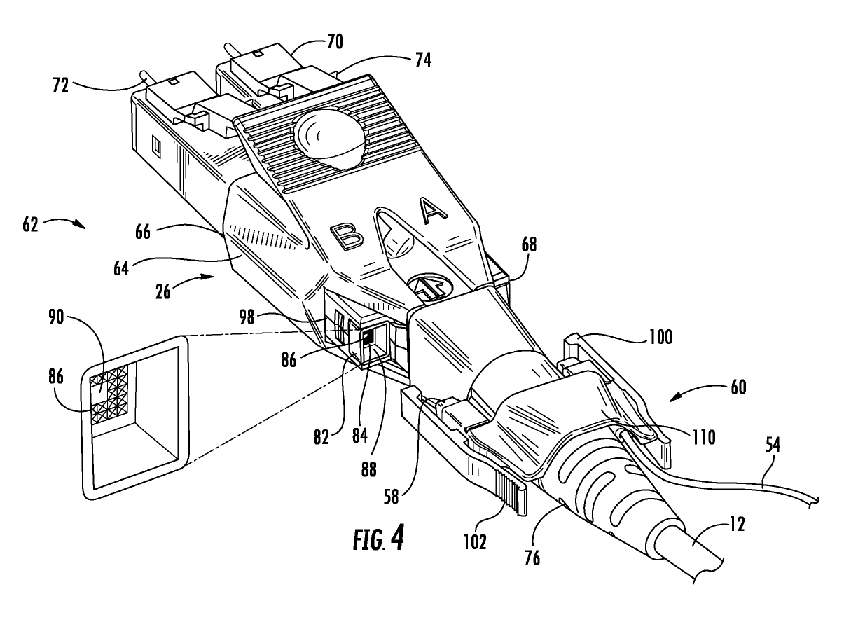

FIG. 4 is a perspective view of one end of an exemplary cable assembly 62 that includes a connector 26, for example a duplex LC fiber optic connector, and a traceable cable 12. The illustrated portion of the cable assembly 62 is shown with the attachment 60 mounted near the emission end 58 of the delivery waveguide 54. In FIG. 4, the attachment 60 is shown separated from the connector 26. In some embodiments, the connector 26 is configured to accept tracer light from the emission end 58 of the delivery waveguide 54 of the launch tool 16, and the connector is further configured emit tracer light received from the tracing optical fiber 36 within the cable 12. One or more diffusers, provided with the connector 26 to facilitate at least one of the above-mentioned functions, will be described in greater detail below after a discussion of optional elements of the connector 26.

The connector 26 may have a connector housing 64 with a first end 66 and a second end 68. The connector 26 may include one or more fiber optic connector sub-assemblies (“connector sub-assemblies”) 70 operably supported by the first end 66 of the connector housing 64. The connector sub-assemblies 70 may include respective ferrules 72 configured to support respective ends of the data transmission elements 28 from the cable 12. The ferrules 72 may be operably supported within the connector sub-assemblies 70 and operatively joined to ends of the data transmission elements 28 by any suitable structure and method. In the example shown, the connector sub-assemblies 70 are LC fiber optic connector sub-assemblies with respective latch arms 74 or other suitable features for engaging and disengaging with elements within the equipment racks 14 (FIG. 1). The connector 26 is not limited to a duplex type with LC fiber optic connector sub-assemblies, and may include any other suitable means for providing a junction for sending and receiving data from the at least one data transmission element within the cable 12.

The second end 68 of the connector housing 64 may be connected to the traceable cable 12. A flexible boot 76 may be connected to the second end 68 of the connector housing 64 to at least partially facilitate or otherwise be associated with a connection between the connector housing and the cable 12. The flexible boot 76 is configured to help prevent sharp bends in the cable 12 where the cable engages the connector housing 64.

The connector housing 64 may include an upper housing 78 and a lower housing 80 (FIG. 6). The terms “upper” and “lower” are used for ease of understanding relative to FIGS. 4 and 6, but are not intended to limit the construction of the connector 26. In an example, the upper housing 78 and the lower housing 80 are configured to mate with one another to form the connector housing 64. An example mating configuration for the connector housing 64 provides a snap-fit connection. In an example, the lower housing 80 may have one or more locking features that snap fit with a corresponding locking feature on the upper housing 78. Alignment features may also be provided inclusive of, or separate from, the locking features to ensure that the upper housing 78 and lower housing 80 are able to fit together in the correct orientation.

As prefaced above, the connector 26 may include one or more diffusers 82 provided at one or more locations relative to the connector housing 64. The diffusers 82 provide an optical path or window from the inside of the connector 26 to the exterior of the connector 26. Tracer light emitted from a terminal end of the tracing optical fiber 36 may be directly or indirectly incident upon an interior side of the diffuser 82 such that the tracer light will pass through the diffuser 82 and exit the connector 26 in a diffuse manner, to be identified during the tracing process. For example, in some embodiments, the tracing optical fiber 36 may extend into the connector housing 64 and be routed so that an end of the tracing optical fiber 36 confronts the interior side of the diffuser 82. In other embodiments, the tracing optical fiber 36 may terminate shortly after entering the connector housing 64, which may include structure or components to redirect tracer light from the tracing optical fiber to the diffuser 82.

Providing a plurality of diffusers 82 in each connector 26 may result in emission of tracer light from more than one portion of the connector 26. This may improve the visibility of the connector 26 because some of the diffusers 82 may be hidden from view when the connector 26 is in use. Diffusers 82 of the present disclosure are configured to diffuse tracer light associated with the tracing optical fiber 36 (FIG. 2), and are not positioned on the connector 26 to impact or alter the signals that may be conducted by the data transmission elements 28 (FIG. 2) of the cable 12. In some embodiments, the diffusers 82 also provide an optical path or window into the connector 26. Providing a plurality of diffusers 82 as part of the connector 26, as seen in FIG. 4, may improve traceability by facilitating injection of tracer light or by improving ease of use because one diffuser may be more accessible than other at a given time.

The diffuser 82 may take several forms. The diffuser 82 may generally diffuse light based on one of several optical phenomenon, including, but not limited to, prismatic scattering and scattering occurring through a translucent optical medium. The diffuser 82 may be a separate part or may be combined with other elements of the connector 26.

The diffuser 82 shown in FIG. 4 is attached to the connector housing 64 in a fixed or stationary manner. In this embodiment, the diffuser 82 both: a) diffuses tracer light exiting the connector 26, b) accepts tracer light being injected (i.e., launched) into the connector 26. This functionality may be described as providing the diffuser with bi-directionality. The ability to inject the tracer light through a stationary diffuser 82 may provide advantages with respect to packaging constraints within the connector 26.

In one example, the diffuser 82 forms a terminal portion of a light pipe optically joined to the terminal end of the tracing optical fiber 36 (FIG. 2). The diffuser 82 may comprise a diffusive emission surface 84 having a plurality of diffusive protrusions 86, such as prisms or the like, such that the diffuser 82 will diffuse tracer light being emitted outwardly from the diffusive emission surface 84. Diffusion of the outwardly emitted tracer light may assist with eye safety and may generally expand the beam of the emitted tracer light for increased visibility by a technician. The diffusive emission surface 84 and the material of the diffuser 82 can also be tuned based on factors such as eye safety, while maximizing the ability to quickly identify the illuminated connector. For example, the diffusive emission surface 84 of the diffuser 82 can be designed to allow the tracer light to expand at an optimized angle where a horizontal angle of expansion can be optimized independently from a vertical angle of expansion. This optimization may provide benefits for connectors 26 placed higher or lower vertically in an equipment rack 14 as compared to connectors positioned at eye level to the technicians.

In the illustrated embodiment, the emission surface 84 is recessed with respect to a forward face 85 of the diffuser 82. Setting back the emission surface 84 may help protect the emission surface 84 from damage. Recessing the emission surface 84 also creates guide walls 88 that may facilitate the desired positioning of the emission end 58 of the delivery waveguide 54 of the launch tool 16 (FIG. 1) for effectively conducting tracer light into the connector 26. For example, the light pipe 59 constituting the emission end 58 of the delivery waveguide 54 may have a peripheral size and shape configured to fit closely within the guide walls 88.

The tracer light may be provided as a single mode beam, or close to single mode, which means the tracer light can be a very narrow and a very low divergence angle beam when leaving the launch tool 16. On the other hand, the tracer light that comes out of a far end of tracing optical fiber 36 will likely be a highly multi-mode beam, which has a wide area and a wide angular divergence. The multi-mode beam may be the result of all of the scattering of modes from the fundamental higher order modes as light propagates down the tracing optical fiber 36. To take advantage of these two very different beam characteristics, the plurality of diffusive protrusions 86 may extend around a substantially planar, central portion 90 of the emission surface 84. The central portion 90 may provide an optically flat portion, clear aperture portion, or a narrow lens, for accepting the input of tracer light. Outside of that central element is the array of diffusive protrusions 86 that will interact with the wide area, wide angle beam coming out of the far end of the tracing optical fiber 36.

The guide walls 88 may extend around and define an outwardly open guiding cavity for receiving and aligning the emission end 58 of the delivery waveguide 54 of the launch tool 16 (FIG. 1) so that the tracer light emitted from the launch tool is coaxially aligned with the substantially planar, central portion 90 of the emission surface 84. When present, this alignment seeks to minimize any diffusion of the inwardly traveling tracer light at the emission surface 84.

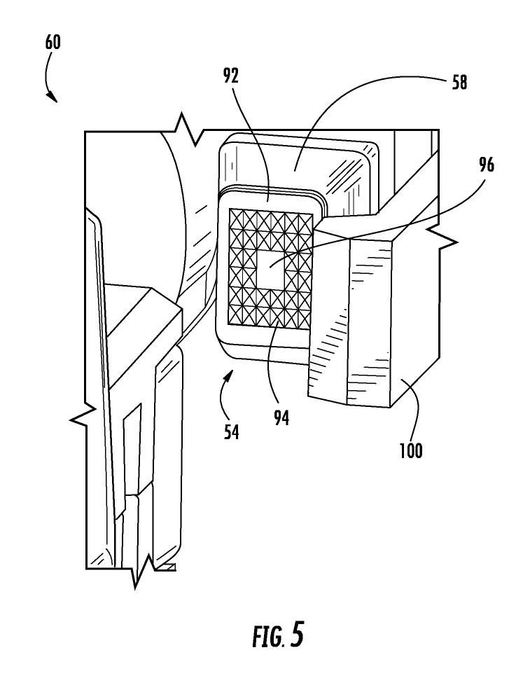

FIG. 5 is a detailed end view of a portion of the attachment 60 mounted adjacent to the emission end 58 of the delivery waveguide 54. An emission face 92 of the emission end 58 of the delivery waveguide 54 is configured to be complimentary to the array of diffusive protrusions 86 of the diffuser 82 (FIG. 4). For example, the emission face 92 may have an array of recesses 94 shaped, sized, and arranged to correspond with the array of diffusive protrusions 86 arranged around an optically flat middle portion 96. The attachment 60 may allow sufficient clearance around the emission face 92 such that the emission end 58 of the delivery waveguide 54 can be inserted into the cavity formed by the guide walls 88 of the diffuser 82 (FIG. 4).

FIG. 6 is a partial cut-away of the attachment 60 mated with the connector housing 64 such that the emission face 92 of the delivery waveguide 54 is in optical communication with the array of diffusive protrusions 86 of the diffuser 82. Use of complimentary surfaces (e.g., configured for substantially continuous, opposing face-to-face contact between the emission face 92 and the diffusive emission surface 84 seeks to minimize or eliminate any air gaps between the diffuser 82 and the emission face 92. Further, the diffuser 82 and the emission face 92 may be constructed from substantially index-matched materials, i.e. each material is either the same or has a substantially similar index of refraction. By minimizing air gaps, and using index-matching materials, the insertion loss effects of the interface between the delivery waveguide 54 and the diffuser 82 are minimized, in effect minimizing the loss of tracer light passing from the launch tool 16 (FIG. 1) to the connector 26.

In the mated pair shown in FIG. 6, tracer light is provided from the delivery waveguide 54 through the diffuser 82 and conducted within the connector housing 64, for example by a light pipe, to a terminal end of the tracing optical fiber 36 (see FIG. 2). The tracer light would then pass down the cable 12 through the tracing optical fiber 36, where the tracer light would reach the opposite connector 26 that is connected at the opposite end of the cable. The tracer light would then be conducted to and through the diffuser 82 that is part of the opposite connector 26, where the tracer light may then be identified by a technician.

As seen in FIGS. 4 and 6, the connector housing 64 may include a first fastening portion 98, such as a recess positioned along an outside of the connector housing 64. A complimentary second fastening portion 100, such as a resilient clip arm, may be provided as part of the attachment 60. Therefore, the first fastening portion 98 and the second fastening portion 100 may be configured to mate with one another to provide a secure connection that aligns the emission end 58 of the delivery waveguide 54 with the connector 26. In the illustrated embodiment, the second fastening portion 100 is coupled to the connector housing 64 and configured to retract when lever arms 102 (FIG. 4) are squeezed together. The attachment 60 in the illustrated embodiment is configured to secure a pair of delivery waveguides 54 (only one of which is shown) to a pair of diffusers 82 provided on opposite sides of the connector 26 relative to the cable 12. The attachment 60 may include a cross-member 110 that extends over and across the cable 12 and/or the boot 76. The cross-member 110 may be configured to grip at least one of the cable 12 and the boot 76. In other embodiments, the attachment 60 may be configured to provide tracer light to only one diffuser 82. The attachment 60 may engage any of the cable 12, the boot 76, and the connector 26. In yet other embodiments, the attachment 60 may be integral with the light pipe 59 (FIG. 6) of the delivery waveguide 54. In such embodiments, the light pipe 59 may be configured with a light splitter such that tracer light from a single delivery waveguide 54 may be distributed for injection into a plurality of diffusers 82.

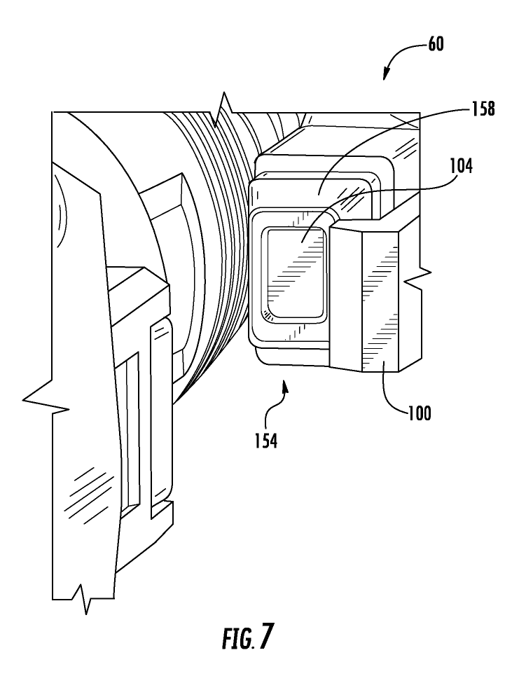

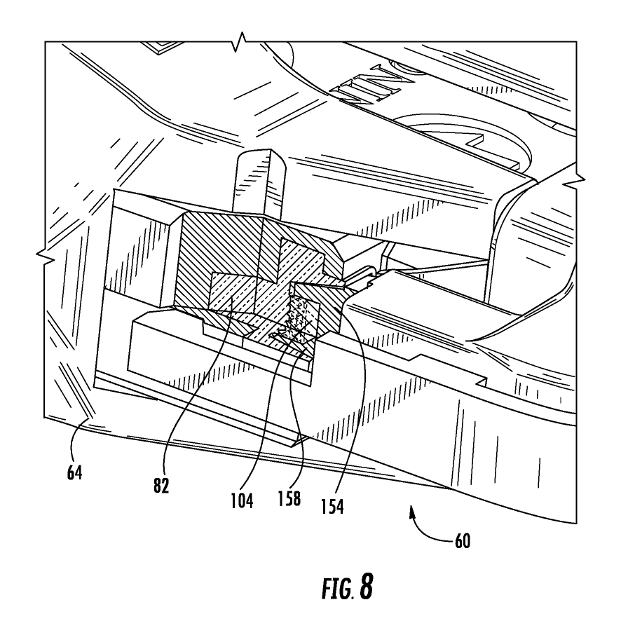

FIG. 7 is a perspective end view of a portion of the attachment 60 mounted on the emission end 158 of a delivery waveguide 154 according to another embodiment. The emission end 158 of the delivery waveguide 154 includes a compliant material 104. The compliant material 104 is index-matched to the remainder of the delivery waveguide 154 and the diffuser 82 (FIG. 4). Instead of relying upon a complimentary emission face 92 (FIG. 5), the compliant material 104 may be configured to engage against and substantially conform to the light diffusive emission surface 84 of the diffuser 82 (FIG. 4). The compliant material 104 is designed to engage against and conform to the geometry of the diffusive emission surface 84 of the diffuser 82, creating an intimate contact between the compliant material 104 and the diffusive emission surface 84. The intimate contact minimizes air gaps between the delivery waveguide 154 and the diffuser 82. The intimate contact of index matched materials reduces the scattering or transmission losses that can occur when light passes between different medium. Index matching between the light pipe 59 (FIG. 8), the compliant material 104, and the diffuser 82 may also reduce optical power loss through the interface. The compliant material 104 may have low stiffness and low optical loss. The integration of the compliant material 104 with the delivery waveguide 154 may be permanent or separable. The separable design may allow the compliant material 104 to be replaceable if the compliant material becomes contaminated beyond a cleanable state, or becomes permanently deformed, having lost sufficient resiliency. The permanent design could leverage high volume manufacturing such as by allowing the compliant material 104 to be directly molded onto the respective end of the delivery waveguide 154 and/or the compliant material 104 may be insert molded into the attachment 60, or the like, potentially saving assembly time and reducing part count. The compliant material 104 may be formed from ultraviolet light curable liquid polymers and thermoplastic elastomers, or other suitable materials.

FIG. 8 is a partial cut-away of the attachment 60 mated with the connector housing 64 such that the emission end 158 of the delivery waveguide 154 is in optical communication with the diffuser 82 through the compliant material 104.

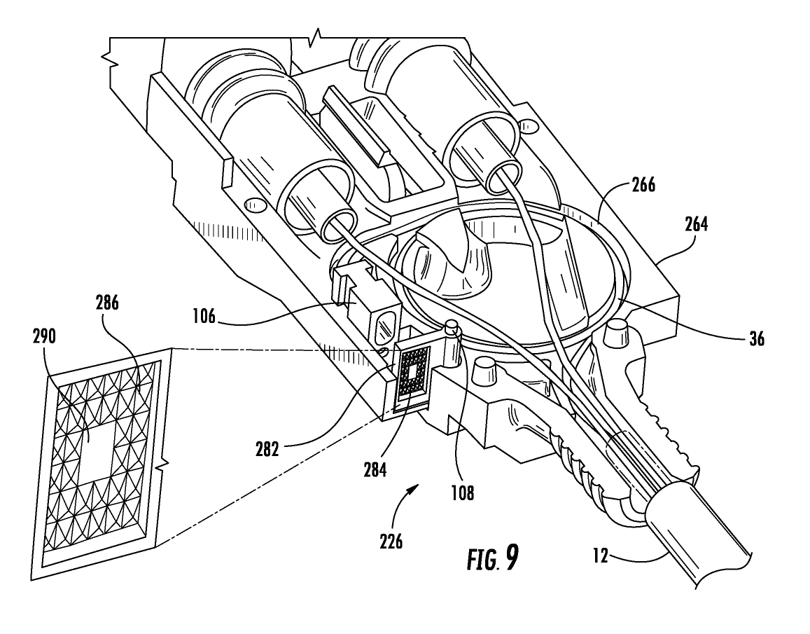

FIG. 9 is a perspective view of an alternative connector 226 shown with an upper housing removed. The tracing optical fiber 36 extends from the cable 12 and is routed through a connector housing 264. In the embodiment shown, the connector housing 264 includes a path or raceway 266 that allows the tracing optical fiber 36 to be looped one or more times within the connector housing before terminating in a different orientation/direction than the one in which the tracing optical fiber enters the connector housing. Advantageously, the path or raceway 266 helps keep the bend radius of the tracing optical fiber 36 sufficiently large to avoid substantial loss of tracer light from along the side of the tracing optical fiber within the connector 226.

Still referring to FIG. 9, the tracing optical fiber 36 terminates in or is otherwise coupled to an expanded beam connector 106. The expanded beam connector 106 uses a lens or similar optical component to manipulate the size of a light beam as the light passes through the expanded beam connector. Light originating within the tracing optical fiber 36 would be spread into a wider beam, providing safety and visibility enhancement. Light originating from a launch tool 16 (FIG. 1) may be converged or collimated by the expanded beam connector 106 for receipt by the tracing optical fiber 36. The expanded beam connector 106 is configured to optically communicate with the emission end of the delivery waveguide (not shown). In one embodiment, the expanded beam connector 106 may mate with the delivery waveguide in a similar male/female connection as shown in FIGS. 6 and 9 where the expanded beam connector 106 may provide an outwardly open cavity configured to receive the emission end of the delivery waveguide.

The connector 226 may further include a diffuser 282. The diffuser 282 includes a diffusive emission surface 284 to diffuse tracer light passing from the tracing optical fiber 36 out of the connector 226 through the diffuser 282. The diffusive emission surface 284 may also include diffusive protrusions 286 at least partially surrounding a central portion 290 similar to the configuration of the stationary diffuser 82 (FIG. 4). In the illustrated embodiment, the diffuser 282 may be in optical communication with the expanded beam connector 106. As discussed above, the stationary diffuser 82 of FIG. 4 both diffuses tracer light being emitted from the connector 26 and accepts launched tracer light from the launch tool 16 (FIG. 1). On the other hand, the diffuser 282 of the present embodiment is configured to be moved relative to the connector housing 264. Moving the diffuser 282 allows tracer light from the launch tool 16 to bypass the diffuser 282 as the tracer light is provided to the tracing optical fiber 36 through the expanded beam connector 106. In one example, the diffuser 282 may be configured to hinge or pivot relative to the connector housing 264 with a pivot pin 108, or the like. The diffuser 282 illustrated in FIG. 9 would pivot into the connector housing 264. In other embodiments, the diffuser 282 may swing outward from the connector housing 264. A spring (not shown) may be provided to bias the diffuser 282 toward a closed position (e.g., as shown in FIG. 9) along an optical path between the tracing optical fiber 36, or more specifically the expanded beam connector 106, and the launch tool 16 or an exterior of the connector housing 264. Having the diffuser 282 biased toward the closed position may help minimize contaminates from entering the connector housing 264. In operation, the emission end 58 (FIG. 3) of the delivery waveguide 54 (FIG. 3), or an associated protruding part of an attachment (e.g., see attachment 60 of FIGS. 3-8) may engage and displace the diffuser 282 (e.g., pivot the diffuser to an open position) as the emission end, or the like, is inserted into the connector housing 264 to optically connect with the expanded beam connector 106. Removal of the emission end 58 of the delivery waveguide 54, or the like, from within the connector housing 264 may cause the diffuser 282 to be biased back to its closed position.

Persons skilled in optical connectivity will appreciate additional variations and modifications of the devices and methods already described. Where a system claim below does not explicitly recite a component mentioned in the description above, e.g. controller 22, it should not be assumed that the component is required by the claim. Additionally, where a method claim below does not explicitly recite a step mentioned in the description above, it should not be assumed that the step is required by the claim. Furthermore, where a method claim below does not actually recite an order to be followed by its steps or an order is otherwise not required based on the claim language, it is not intended that any particular order be inferred.

The above examples are in no way intended to limit the scope of the present invention. It will be understood by those skilled in the art that while the present disclosure has been discussed above with reference to examples of embodiments, various additions, modifications and changes can be made thereto without departing from the spirit and scope of the invention as set forth in the claims.

1. A traceable cable assembly, comprising:
a traceable cable, comprising:
at least one data transmission element,
a jacket at least partially surrounding the at least one data transmission element, and
a tracing optical fiber incorporated with and extending along at least a portion of a length of the traceable cable; and
a connector provided at each end of the traceable cable, each connector comprising:
a connector housing having opposed first and second ends the second end being coupled to the traceable cable; and
a diffuser supported by the connector housing, wherein the connector housing is configured to receive tracer light from the tracing optical fiber and allow the tracer light to leave the connector housing, and further wherein the diffuser is configured to diffuse the tracer light leaving the connector housing, wherein the diffuser is fixed to the connector housing and configured to permit tracer light to be delivered into the connector to the tracing optical fiber.

2. (canceled)

3. The traceable cable assembly of claim 1, wherein the diffuser comprises a front face oriented away from the connector housing and a diffusive emission surface recessed from the front face.

4. The traceable cable assembly of claim 1, wherein the diffuser is movable relative to the connector housing such that the connector is configured to accept tracer light that bypasses the diffuser.

5. The traceable cable assembly of claim 4, wherein the diffuser is configured to pivot into the connector housing.

6. The traceable cable assembly of claim 1, wherein the diffuser comprises an array of diffusive protrusions.

7. The traceable cable assembly of claim 6, wherein the diffuser further comprises a central region, and wherein the array of diffusive protrusions extend at least partially around the central region.

8. The traceable cable assembly of claim 1, wherein the connector housing includes a path for routing the tracer optical fiber to the diffuser, and further wherein the tracing optical fiber is looped one or more times in the path.

9. The traceable cable assembly of claim 1, wherein the connector further comprises an expanded beam connector supported by the connector housing, wherein the expanded beam connector is configured to converge or collimate the tracer light into the tracing optical fiber.

10. A traceable cable system, comprising:
a traceable cable, comprising:
at least one data transmission element,
a jacket at least partially surrounding the at least one data transmission element, and
a tracing optical fiber incorporated with and extending along at least a portion of a length of the traceable cable;
a connector provided at each end of the traceable cable, each connector comprising:
a connector housing having opposed first and second ends, the second end being coupled to the traceable cable, and
a diffuser supported by the connector housing; and
a launch tool, comprising:
a light source configured to produce tracer light, and
a waveguide having opposite receiving and emissions ends, wherein the receiving end is in optical communication with the light source,
wherein:
the launch tool is configured to at least indirectly provide tracer light to the tracing optical fiber proximate one end of the traceable cable;
the connector housing coupled to an opposite end of the traceable cable is configured to receive the tracer light from the tracing optical fiber and allow the tracer light to leave the connector housing; and
the diffuser is configured to diffuse the tracer light leaving the connector housing such that the tracer light is visible proximate the opposite end of the traceable cable, wherein the diffuser is fixed to the connector housing such that the diffuser permits tracer light to be delivered into the connector to the tracing optical fiber from the launch tool.

11. (canceled)

12. The traceable cable system of claim 10, wherein the diffuser comprises an array of diffusive protrusions, and wherein the emission end of the waveguide comprises an emission face complimentary to the array of diffusive protrusions.

13. The traceable cable system of claim 10, wherein the emission end of the waveguide comprises a compliant material index-matched to the diffuser, and
wherein the compliant material is configured to abut the diffuser to minimize any air gaps therebetween.

14. The traceable cable system of claim 10, wherein the diffuser comprises a front face oriented away from the connector housing and a diffusive emission surface recessed from the front face, and further wherein a plurality of guide walls of the diffuser form a cavity at least partially around the diffusive emission surface.

15. The traceable cable system of claim 14, wherein the emission end of the waveguide of the launch tool is configured to fit within the cavity.

16. The traceable cable system of claim 10, wherein the diffuser comprises an array of diffusive protrusions.

17. The traceable cable system of claim 16, wherein the diffuser further comprises a central region, and wherein the array of diffusive protrusions extend at least partially around the central region.

18. The traceable cable system of claim 10, wherein the diffuser is movable relative to the connector housing such that the tracer light provided by the launch tool can reach the tracing optical fiber without passing through the diffuser.

19. The traceable cable system of claim 18, wherein the diffuser is configured to pivot into the connector housing when a portion of the launch tool engages the diffuser and extends into the connector housing.

20. The traceable cable system of claim 10, wherein the connector housing comprises a first fastening portion and the waveguide comprises a second fastening portion, the second fastening portion being configured to mate with the first fastening portion, and
wherein mating the first fastening portion to the second fastening portion substantially aligns the emission end of the waveguide with the connector.

21. The traceable cable system of claim 10, wherein the connector housing includes a path for routing the tracer optical fiber to the diffuser, and further wherein the tracing optical fiber is looped one or more times in the path.

22. The traceable cable system of claim 10, wherein the connector further comprises an expanded beam connector supported by the connector housing, wherein the expanded beam connector is configured to converge or collimate the tracer light from the launch tool into the tracing optical fiber.

23. A traceable cable assembly, comprising:
a traceable cable, comprising:
at least one data transmission element,
a jacket at least partially surrounding the at least one data transmission element, and
a tracing optical fiber incorporated with and extending along at least a portion of a length of the traceable cable; and
a connector provided at each end of the traceable cable, each connector comprising:
a connector housing having opposed first and second ends, the second end being coupled to the traceable cable, and
a diffuser supported by the connector housing; and
wherein:
the connector housing includes a path that directs the tracer optical fiber from the traceable cable to the diffuser;
the tracing optical fiber is looped one or more times in the path of the connector housing; and
the diffuser is configured to receive tracer light from the tracing optical fiber and diffuse the tracer light such that the tracer light is visible proximate the connector that includes the diffuser, wherein the diffuser is fixed to the connector housing and configured to permit tracer light to be delivered into the connector to the tracing optical fiber.
